(19) United States
(12) Patent Application Publication
(10) Pub. No.: US 2026/0032603 A1
(43) Pub. Date: Jan. 29, 2026

(54) DISTRIBUTED RESOURCE UNIT SHARING

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US)

(73) Assignee: Ofinno, LLC, Reston, VA (US)

(21) Appl. No.: 19/345,014

(22) Filed: Sep. 30, 2025

Related U.S. Application Data
(63) Continuation of application No. PCT/US2024/021960, filed on Mar. 28, 2024.
(60) Provisional application No. 63/455,596, filed on Mar. 30, 2023.

(51) Int. Cl. H04W 52/18

(52) U.S. Cl. CPC H04W 52/18

(57) ABSTRACT

A first station (STA) receives from an overlapping basic service set (OBSS) access point (AP), a trigger frame alocating a first distributed resource unit, within a frequency channel bandwidth. The first STA transmits a data portion of a first physical layer protocol data unit (PPDU) via a second distributed resource unit, within the frequency channel bandwidth, that is not allocated by the trigger frame.

### CROSS-REFERENCE TO RELATED APPLICATIONS

This application is a continuation of International Application No. PCT/US2024/021960, filed Mar. 28, 2024, which claims the benefit of U.S. Provisional Application No. 63/455,596, filed Mar. 30, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example network that includes a coordinated AP set.

FIG. 4 illustrates an example that includes buffer status reporting by STAs, scheduling by an AP of an uplink multi-user (MU) transmission, and transmission of scheduled uplink transmissions by the STAs.

FIG. 5 illustrates an example trigger frame.

FIG. 6 illustrates an example of parameterized spatial reuse (PSR)-based spatial reuse (SR) operation.

FIG. 7 illustrates an example allocation of non-distributed resource units.

FIG. 8 illustrates an example allocation of distributed resource units.

FIG. 9 illustrates an example of operation using distributed resource units.

FIG. 10 illustrates example physical layer protocol data units (PPDUs) which may be used by ultra-high reliability (UHR) devices according to the IEEE 802.11 standard.

FIG. 11 illustrates another example of operation using distributed resource units.

FIG. 12 illustrates an example of operation using distributed resource units according to an embodiment.

FIG. 13 illustrates another example of operation using distributed resource units according to an embodiment.

FIG. 14 illustrates an example trigger frame which may be used in embodiments.

FIG. 15 illustrates an example process according to an embodiment.

FIG. 16 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every clement of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAS, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

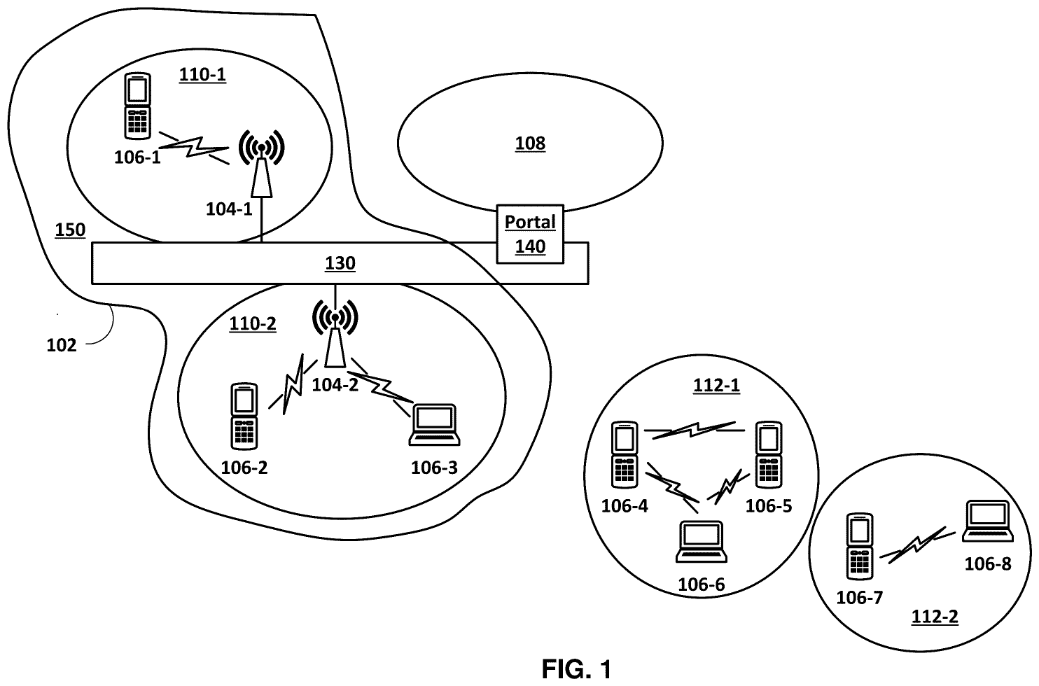

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

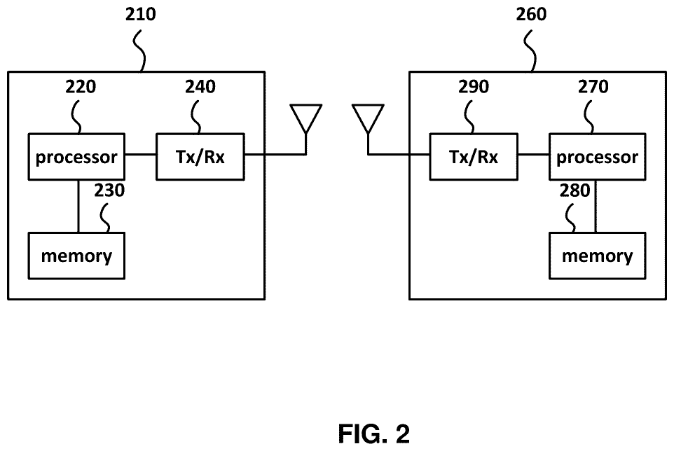

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

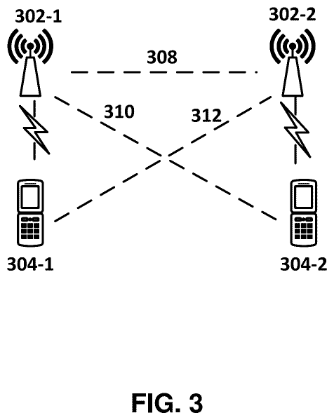

FIG. 3 illustrates an example network 300 that includes a coordinated AP set. As shown in FIG. 3, the coordinated AP set may include two APs—AP 302-1 and AP 302-2. At least one STA may be associated with each of APs 302-1 and 302-2. For example, a STA 304-1 may be associated with AP 302-1, and a STA 304-2 may be associated with AP 302-2.

APs 302-1 and 302-2 may belong to the same ESS as described above in FIG. 1. In such a case, APs 302-1 and 302-2 may be connected by a DS to support ESS features. In addition, as part of a coordinated AP set, APs 302-1 and 302-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 302-1 and 302-2 may act as a master AP and the other as a slave AP. The master AP is the AP that is the owner of the TXOP. The master AP shares frequency resources during the TXOP with the slave AP. When there are more than two APs in the coordinated set, a master AP may share its TXOP with only a subset of the coordinated AP set. The role of the master AP may change over time. For example, the master AP role may be assigned to a specific AP for a duration of time. Similarly, the slave AP role may be chosen by the master AP dynamically or can be pre-assigned for a duration of time.

Spatial reuse (SR) with AP coordination across multiple BSSs (known as Coordinated Spatial Reuse (CSR)) can be more stable than non-AP coordinated spatial reuse schemes such as overlapping basic service set (OBSS) packet detect (PD)-based SR and parameterized spatial reuse (PSR)-based SR. For example, in example 300, APs 302-1 and 302-2 may perform a joint sounding operation in order to measure path loss (PL) on paths of network 300. For example, the joint sounding operation may result in the measurement of PL 308 for the path between APs 302-1 and 302-2, path loss 310 for the path between AP 302-1 and STA 304-2, and path loss 312 for the path between AP 302-2 and STA 304-1. The measured path loss information may then be shared between APs 302-1 and 302-2 (e.g., using the backhaul) to allow for simultaneous transmissions by APs 302-1 and 302-2 to their associated STAs 304-1 and 304-2 respectively. Specifically, one of APs 302-1 and 302-2 obtains a TXOP to become the master AP. The master AP may then send a CSR announcement frame to the other AP(s). In an embodiment, the master AP may perform a polling operation, before sending the CSR announcement frame, to poll slave APs regarding packet availability for transmission. If at least one slave AP responds indicating packet availability, the master AP may proceed with sending the CSR announcement frame. In the CSR announcement, the master AP may limit the transmit power of a slave AP in order to protect its own transmission to its target STA. The slave AP may similarly protect its own transmission to its target STA by choosing a modulation scheme that enables a high enough Signal to Interference Ratio (SIR) margin to support the interference due to the transmission of the master AP to its target STA.

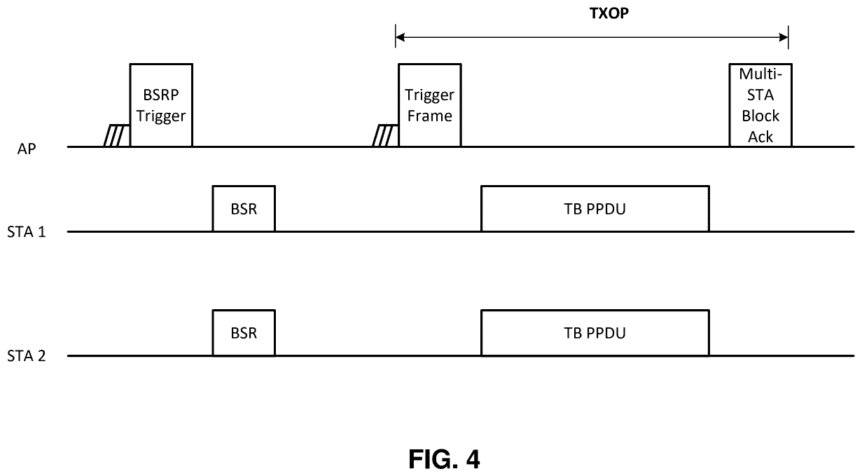

FIG. 4 illustrates an example that includes buffer status reporting by STAs, scheduling by an AP of uplink multi-user (MU) transmissions, and transmission of scheduled uplink transmissions by the STAs.

As shown, the AP may solicit one or more associated STAs (STA 1 and STA 2) for buffer status by sending a buffer status report poll (BSRP) trigger frame. Upon receiving the BSRP trigger frame, STA 1 and/or STA 2 may each generate a trigger-based (TB) PPDU if the BSRP trigger frame contains, in a User Info field, the 12 LSBs of the STA's AID.

STA 1 and/or STA 2 may each include in the TB PPDU one or more QoS null frames. The one or more QoS null frames may contain one or more QoS control fields or one or more BSR control subfields.

As described earlier, a QoS control field may include a queue size subfield for a traffic identifier (TID) for which the STA has a queue size to report to the AP. For example, as shown in FIG. 4, STA 1 may respond to the BSRP trigger frame from the AP by transmitting an A-MPDU including multiple QoS null frames. The QoS null frames each indicates, in its respective QoS control field, a queue size for a respective TID, e.g., TID 0 and TID 2. Similarly, STA 2 may respond to the BSRP trigger frame by transmitting an MPDU including a QoS null frame, which indicates a queue size for TID 2 in its QoS control field.

A BSR control subfield may include a queue size all subfield indicating the queue size for the ACs, indicated by the ACI bitmap subfield, for which the STA has a queue size to report to the AP if the AP has indicated its support for receiving the BSR control subfield. The STA sets a delta TID, a scaling factor, an ACI high, and the queue size high subfields of the BSR Control subfield.

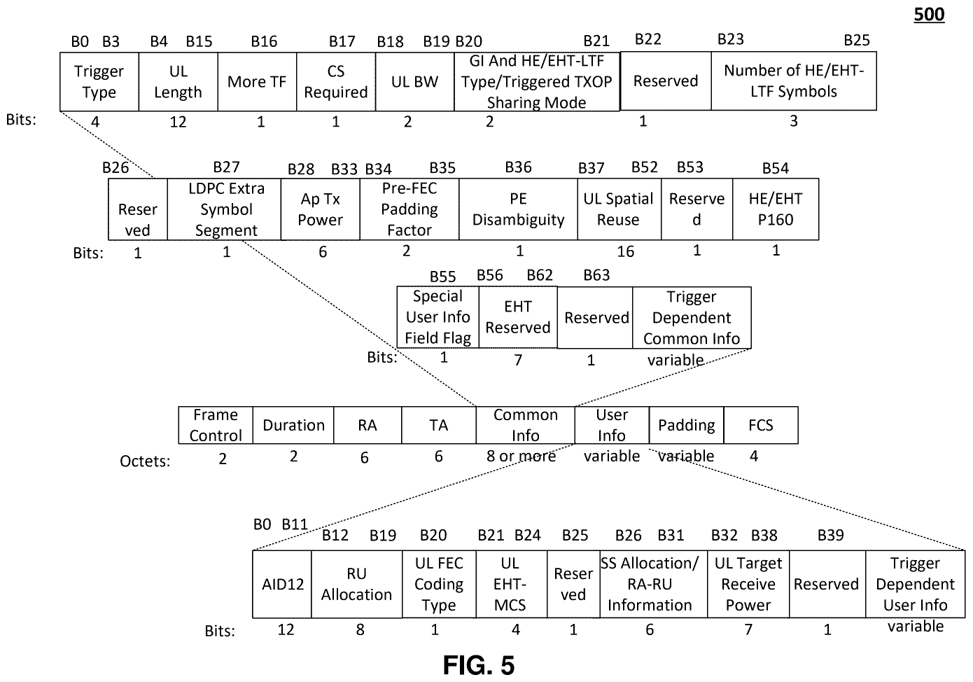

On receiving the BSRs from STA 1 and STA 2, the AP may transmit a basic trigger frame to allocate UL resources to STA 1 and STA 2. The trigger frame may have a format as described below with reference to FIG. 5. In MU-OFDMA, the UL resources allocated to STA 1 and STA 2 include different (non-overlapping) sets of frequency subcarriers (or tones). In response, STA 1 may transmit a TB PPDU containing QoS data frames with TID 0 and TID 2 and STA 2 may transmit a TB PPDU containing one or more QoS data frame(s) with TID 2. The AP may acknowledge the transmitted TB PPDUs from STA 1 and STA 2 by sending a multi-STA BlockAck frame.

FIG. 5 illustrates an example trigger frame 500. Trigger frame 500 may correspond to a basic trigger frame as defined in the existing IEEE 802.11ax standard amendment. Trigger frame 500 may be used by an AP to allocate resources for and solicit one or more TB PPDU transmissions from one or more STAs. Trigger frame 500 may also carry other information required by a responding STA to transmit a TB PPDU to the AP.

As shown in FIG. 5, trigger frame 500 includes a Frame Control field, a Duration field, a receiver address (RA) field, a transmitter address (TA) field, a Common Info field, a User Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 500 if trigger frame 500 is addressed to STAs that belong to a single BSS. The TA field is the transmitted BSSID if the trigger frame 500 is addressed to STAs from at least two different BSSs of the multiple BSSID set.

The Common Info field specifies a trigger frame type of trigger frame 500, a transmit power of trigger frame 500 in dBm, and several key parameters of a TB PPDU that is transmitted by a STA in response to trigger frame 500. The trigger frame type of a trigger frame used by an AP to receive QoS data using UL MU operation is referred to as a basic trigger frame.

The User Info field contains a User Info field per STA addressed in trigger frame 500. The per STA User Info field includes, among others, an AID subfield, an RU Allocation subfield, a Spatial Stream (SS) Allocation subfield, an MCS subfield to be used by a STA in a TB PPDU transmitted in response to trigger frame 500, and a Trigger Dependent User Info subfield. The Trigger Dependent User Info subfield i can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 500 to extend the frame length to give recipient STAs enough time to prepare a response for transmission one SIFS after the frame is received. The Padding field, if present, is at least two octets in length and is set to all 1 s.

The FCS field is used by a STA to validate a received frame and to interpret certain fields from the MAC headers of a frame.

PSR-based SR is a spatial reuse mode that allows a STA to transmit within a duration of a Trigger Based (TB) PPDU sent from an OBSS network. A TB PPDU is a PPDU sent by a STA in response to a Triggering Frame. A Triggering Frame can be a Trigger Frame (TF) variant Control Frame or any frame with a Triggered Response Scheduling (TRS) control subfield in its MAC header. Opportunities for PSR-based SR are identified by the reception of an inter-BSS PPDU that contains a Triggering Frame.

Transmissions using PSR-based SR are controlled in terms of transmit power and/or duration by the STA that transmits the Triggering Frame. The STA may specify acceptable interference levels dynamically for each TB PPDU it solicits by the Triggering Frame.

For a STA, a PSR-based SR opportunity is identified if the following two conditions are met: Condition 1) The STA receives a Parameterized Spatial Reuse Reception (PSRR) PPDU (a PPDU that is identified as an inter-BSS PPDU and that contains a TF); and Condition 2) The STA has a PPDU queued to be transmitted and the intended transmit power of the PPDU (this PPDU hereinafter is called PSR Transmission PPDU (PSRT PPDU)) in dBm, minus log10(PPDU_BW/20 MHz) dB, is below a power threshold value PSRT_TXP, where PPDU_BW represents a value in MHz of the bandwidth of the PSRR PPDU.

The power threshold value PSRT_TXP may be obtained by subtracting a parameter PSR indicated in 1) a UL Spatial Reuse field of the TF contained in the PSRR PPDU (e.g., indicated in EHT Spatial Reuse 1 or 2 subfields of the TF as shown in FIG. 4) or 2) the preamble of a TB PPDU that follows the PSRR PPDU (e.g., from a parameter RPL). The parameter RPL may be equal to the combined transmit power at a receive antenna connector, over the PSRR PPDU bandwidth, during the non-HE or non-EHT portion of the PSRR PPDU preamble, averaged over all antennas used to receive the PSRR PPDU.

A STA that identifies a PSR-based SR opportunity may issue a reset to its PHY circuitry to ignore (e.g., terminate reception of) any TB PPDU triggered by the TF contained in the PSRR PPDU, provided that the BSS Color of the TB PPDU matches the BSS Color of the PSRR PPDU. A STA that identifies a PSR-based SR opportunity may not be allowed to transmit a PSRT PPDU that terminates beyond the duration of the TB PPDU that is triggered by the TF contained in the PSRR PPDU.

For a STA, transmitting a PSRT PPDU may require detection of the PHY header of the TB PPDU following an identified PSRR PPDU. Because of this, transmission of the PSRT PPDU may only begin after the TB PPDU has been transmitted by a STA responding to the TF contained in the PSRR PPDU. The transmission of the PSRT PPDU as well as any corresponding acknowledgements also needs to terminate at or before the end of the transmission of the TB PPDU.

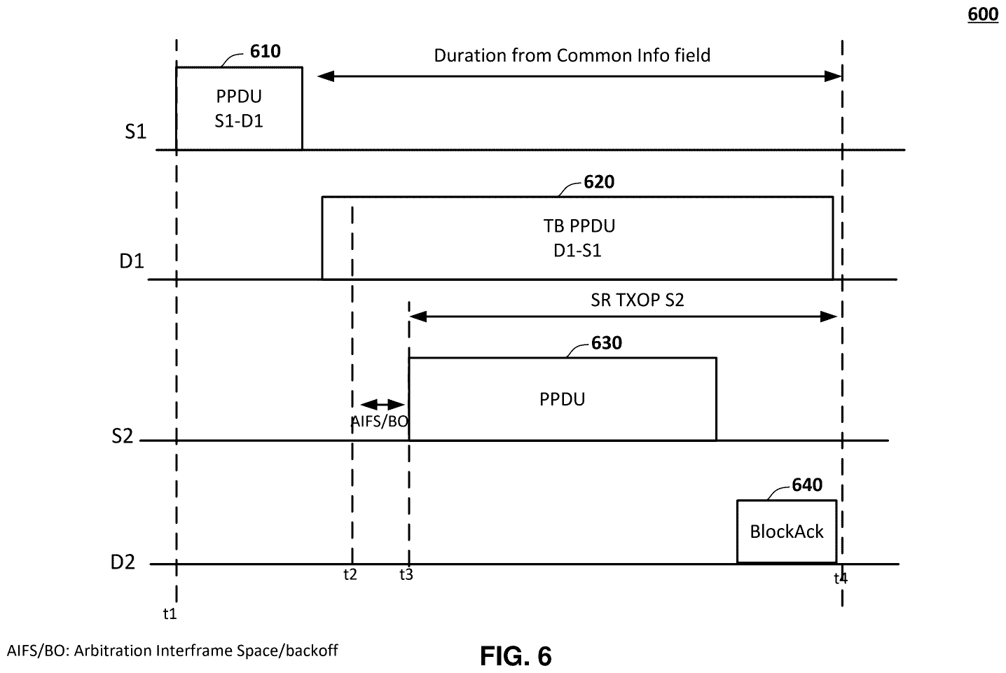

FIG. 6 illustrates an example 600 of PSR-based SR operation. Example 600 includes an AP S1, a STA D1, a STA/AP S2, and an AP/STA D2. S1 and D1 may belong to a different BSS (OBSS) than S2 and D2.

In example 600, S1 transmits a PPDU 610 containing a trigger frame (TF) to D1 at time t1. In response, D1 may transmit a TB PPDU 620 at time t2. D1 may decode spatial reuse subfields of the TF contained in PPDU 610 and may copy the values of the spatial reuse subfields in a universal signal field (U-SIG) of TB PPDU 620.

S2 may hear the transmission of TB PPDU 620 and may identify a PSR opportunity based on TB PPDU 620. Specifically, S2 may determine both that PPDU 610 is an inter-BSS PPDU (based on BSS color information in a preamble of TB PPDU 620) and that PPDU 610 contains a TF (that is, PPDU 610 is a Parameterized Spatial Reuse Reception (PSRR) PPDU for S2) and that the PSRT_TXP computed based on PPDU 610 is enough to transmit a PSRT PPDU by S2. As such, after a backoff count of S2 decrements to 0, S2 may transmit a PPDU 630 to D2. PPDU 630 is considered a PSRT PPDU. S2 sets the duration of PPDU 630 to be short enough such that an expected BlockAck frame 640 from D2 can still be transmitted within the duration indicated in the Common Info field of the TF contained in PPDU 610.

As mentioned above, an AP may allocate UL resources to STA(s) for transmission of TB PPDU(s) to the AP. The UL resources may be allocated using a trigger frame as described above. The trigger frame may indicate a duration and an UL bandwidth of the solicited TB PPDU(s), and a resource unit (RU) allocation for one or more STA being allocated by the trigger frame. The RU allocation for a given STA may include one or more RUs. This may depend on the UL bandwidth of the solicited TB PPDU and/or whether the UL bandwidth is being shared by more than one STA (e.g., MU OFDMA). The size of an RU is defined by the number of tones (subcarriers) in the RU. The IEEE 802.11 standard defines different RU types that range in size from 26 tones (26-tone RU) to 996 tones (996-tone RU). Table 27-6 of the IEEE 802.11 standard (“IEEE P802.11-REVme/D2.1, January 2023”) provides the maximum number of RUs that a PPDU (e.g., TB PPDU or SU/MU PPDU) can have as a function of the bandwidth of the PPDU and the RU type used in the PPDU. It is noted that an MU PPDU used for MU OFDMA may carry a mixture of RU types.

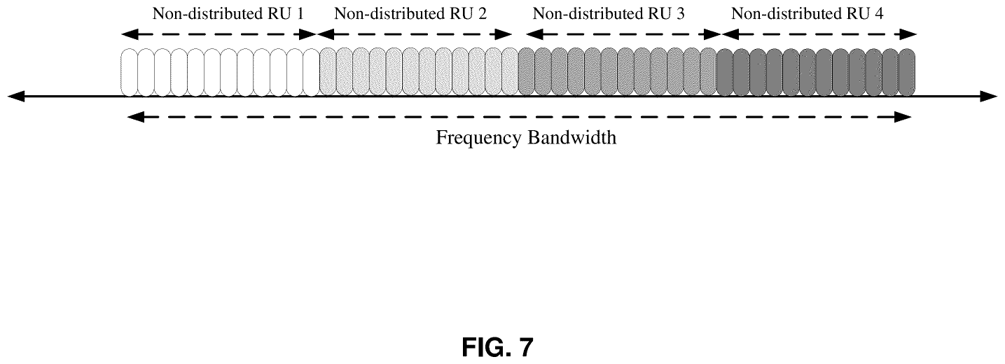

Tables 27-7, 27-8, and 27-9 of the IEEE 802.11 standard provide the RU indices and subcarrier ranges for RUs, for different RU type and PPDU bandwidth combinations. For example, for a 52-tone RU and a 20 MHz PPDU bandwidth, the PPDU may have four RUs, indexed RU 1, RU 2, RU 3, and RU 4. RU 1 corresponds to the subcarrier range [−121:−70], RU 2 corresponds to the subcarrier range [−68:−17], RU 3 corresponds to the subcarrier range [17:68], and RU 4 corresponds to the subcarrier range [70:121]. For example, an allocation comprising RU 1, RU 2, RU 3, and RU 4 may be as illustrated in FIG. 7. As shown, RU 1, RU 2, RU 3, and RU 4 each includes a contiguous set of tones over a respective part of the PPDU bandwidth. The respective parts of the PPDU bandwidth covered by different RUs are non-overlapping and may be separated from one another by one or more null tones. In the case that a PPDU comprises a single RU, the set of tones of the RU cover the entire PPDU bandwidth.

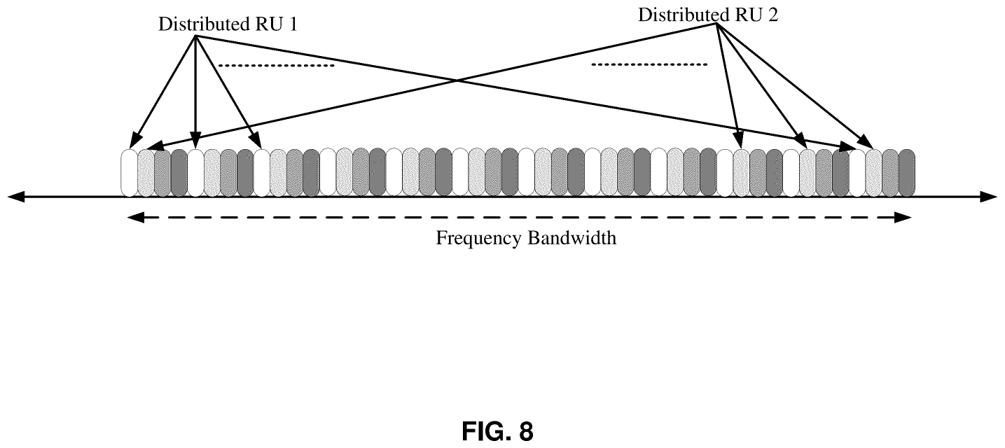

The existing IEEE 802.11 standard defines only RUs including contiguous sets of tones (e.g., as illustrated in FIG. 7). Such RUs are hereinafter referred to as non-distributed RUs. U.S. Pat. No. 11,044,057 proposes an RU, called distributed RU, that includes a non-contiguous set of tones spread over the PPDU bandwidth. An example allocation of distributed RUs is shown in FIG. 8. As shown, rather than an RU being composed of a contiguous set of tones that cover a respective part only of the PPDU bandwidth, a distributed RU includes a non-contiguous set of tones that may be spread over the entire bandwidth of the PPDU.

Spreading the RU over the entire PPDU bandwidth significantly decreases the power spectral density (PSD) of the PPDU. This may enable the device (e.g., AP or STA) transmitting the PPDU to operate in spectrum parts having more stringent PSD requirements. For example, expanded unlicensed use of the 6 Gigahertz Band permits operation over an additional 1.2 GHz of bandwidth (operating bands U-NII-5 (5.925-6.425 GHz), U-NII-6 (6.425-6.525 GHz), U-NII-7 (6.525-6.875 GHz), and U-NII-8 (6.875-7.125 GHz) under low power indoor (LPI) PSD requirements (5 dBm/MHz for an AP and −1 dBm/MHz for a STA). Alternatively, or additionally, the device may leverage the lower PSD resulting from the use of distributed RUs to increase the transmit power of the PPDU. This may be particularly useful in UL MU OFDMA as it would allow each transmitting STA to boost its transmit power, resulting in higher received powers for all tones and a significantly enhanced overall spectrum efficiency.

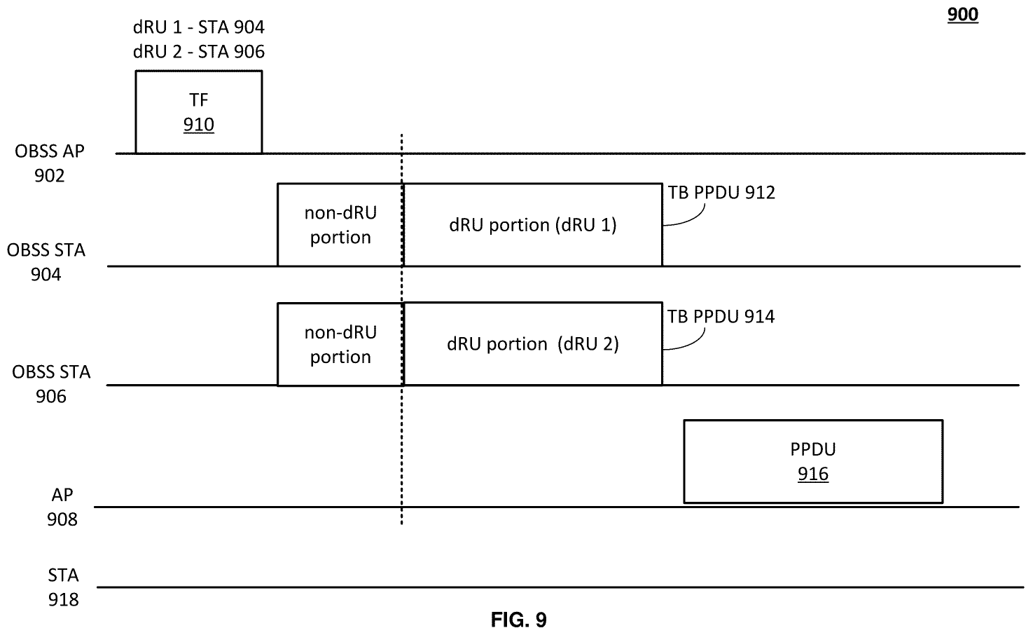

FIG. 9 illustrates an example 900 of operation using distributed RUs. As shown in FIG. 9, example 900 includes APs 902 and 908 and STAs 904, 906, and 918. AP 902 may belong to a first BSS. STAs 904 and 906 may be associated with AP 902 and may thus belong to the first BSS. AP 908 may belong to a second BSS different than the first BSS. STA 918 may be associated with AP 908 and may thus belong to the second BSS. The first BSS and the second BSS may operate on the same channel(s) and may have overlapping coverage areas. In example 900, it is assumed that AP 902 and STAs 904 and 906 belong to an overlapping BSS (OBSS) relative to AP 908. Hence, AP 902, STA 904, and STA 906 are referred to respectively as OBSS AP 902, OBSS STA 904, and OBSS STA 906 in example 900.

Example 900 may begin with OBSS AP 902 transmitting a trigger frame 910. Trigger frame 910 may be similar to trigger frame 500. In example 900, trigger frame 910 may solicit an uplink MU transmission from OBSS STAs 904 and 906 as described above in FIG. 4. The uplink MU transmission may comprise simultaneous transmissions by OBSS STAs 904 and 906 of respective TB PPDUs 912 and 914. The uplink MU transmission may be associated with a frequency channel bandwidth over which TB PPDUs 912 and 914 are transmitted. Trigger frame 910 may thus comprise an RU allocation for OBSS STAs 904 and 906 to transmit TB PPDUs 912 and 914 to OBSS AP 902. The RU allocation may allocate one or more distributed RUs to each of OBSS STAs 904 and 906. In example 900, the RU allocation may allocate a first distributed RU (dRU 1) to OBSS STA 904 and a second distributed RU (dRU 2) to OBSS STA 906. dRU 1 and dRU 2 may be as illustrated in FIG. 8 described above. Specifically, each of dRU 1 and dRU 2 may comprise a non-contiguous set of tones that may be spread over the entire frequency channel bandwidth associated with the uplink MU transmission.

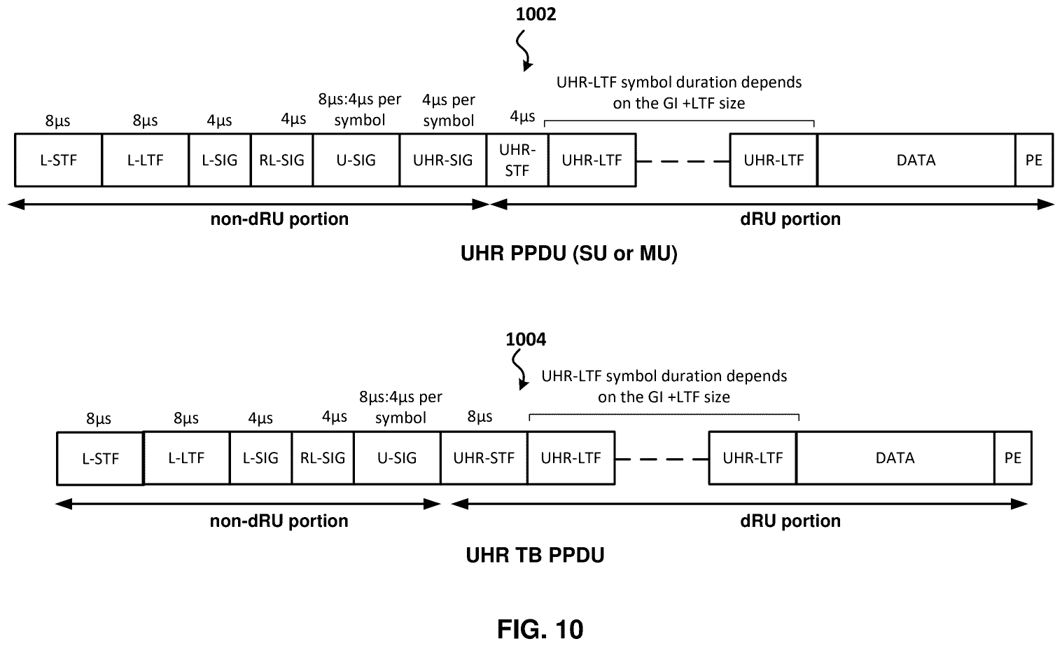

In response to trigger frame 910, OBSS STAs 904 and 906 may transmit respectively TB PPDUs 912 and 914. In an example, as shown in FIG. 9, TB PPDUs 912 and 914 may each comprise a non-distributed resource portion (non-dRU portion) and a distributed resource portion (dRU portion). The non-dRU portion of TB PPDU 912 (or TB PPDU 914) may comprise a preamble portion of TB PPDU 912 (or TB PPDU 914). The dRU portion of TB PPDU 912 (or TB PPDU 914) may comprise a data portion (comprising a data field) of TB PPDU 912 (or TB PPDU 914). In an example, TB PPDUs 912 and 914 may be ultra-high reliability (UHR) TB PPDUs used by UHR devices according to the IEEE 802.11 standard. In an example, TB PPDUs 912 and 914 may have a format as illustrated by TB PPDU 1004 described further below with respect to FIG. 10. The non-dRU and dRU portions of TB PPDU 912 (or TB PPDU 914) may correspond respectively to the non-dRU portion and the dRU portion of TB PPDU 1004, for example.

In an example, the dRU portions of TB PPDUs 912 and 914 may be transmitted over respectively dRU 1 and dRU 2 as indicated by trigger frame 910. In an example, the non-dRU portion of TB PPDU 912 (and/or TB PPDU 914) may be transmitted over one or more non-distributed RUs. The one or more non-distributed RUs may correspond respectively to one or more contiguous sets of resources that may cover respectively one or more parts of the frequency channel bandwidth of the uplink MU transmission. For example, the one or more non-distributed RUs may be as illustrated in FIG. 7 described above. In an example, the non-dRU portions of TB PPDUs 912 and 914 may be transmitted over the same or frequency overlapping non-distributed RUs. In another example, the non-dRU portions of TB PPDUs 912 and 914 may be transmitted over different or frequency non-overlapping non-distributed RUs. In an example, trigger frame 910 may indicate the one or more non-distributed RUs for transmission of the non-dRU portions of TB PPDUs 912 and 914. In another example, the non-dRU portions of TB PPDUs 912 and 914 may be transmitted over the entire frequency channel bandwidth of the uplink MU transmission.

In an example, as OBSS AP 902 and OBSS STAs 904 and 906 belong to an OBSS relative to AP 908, AP 908 may hear one or more of trigger frame 910 and TB PPDUs 912 and 914. In example 900, AP 908 may hear trigger frame 910. As trigger frame 910 allocates to OBSS STAs 904 and 906 distributed RUs that are spread over the entire frequency channel bandwidth, according to existing AP behavior as defined by the current IEEE 802.11 standard, AP 908 cannot locate an unused portion of the frequency channel bandwidth (as it is capable of doing when trigger frame 910 allocates only non-distributed RUs to OBSS STAs 904 and 906). As such, AP 908 may choose not to access the wireless medium concurrently with the uplink MU transmission (comprising TB PPDUs 912 and 914). Instead, AP 908 may update its NAV based on trigger frame 910 and may wait until an end of transmission of TB PPDUs 912 and 914 before attempting to access the wireless medium to transmit a PPDU 916 to STA 918. When PPDU 916 comprises low latency traffic, the transmission of the low latency traffic may be delayed. In addition, the frequency channel bandwidth may be under-utilized when only a few distributed RUs are allocated by trigger frame 910. It is noted that OBSS AP 902 may avoid allocating multiple distributed RUs to the same STA as such an allocation would cause the STA to have to reduce its transmit power, defeating one of the purposes of using distributed RUs.

FIG. 10 illustrates example PPDUs 1002 and 1004 which may be used by UHR devices according to the IEEE 802.11 standard. Two UHR PPDUs are illustrated in FIG. 10: a UHR PPDU illustrated by UHR PPDU 1002 and a UHR trigger-based (TB) PPDU illustrated by UHR TB PPDU 1004.

UHR PPDU 1002 may be used for transmission to one or more users. When used to transmit to a single user, UHR PPDU 1002 is referred to as a UHR single user (SU) PPDU. When used to transmit to multiple users, UHR PPDU 1002 is referred to as a UHR multi-user (MU) PPDU. As shown in FIG. 10, UHR PPDU 1002 includes a Legacy Short Training field (L-STF), a Legacy Long Training field (L-LTF), a Legacy Signal field (L-SIG), a Repeated Legacy Signal field (RL-SIG), a Universal Signal field (U-SIG), a UHR Signal field (UHR-SIG), a UHR Short Training field (UHR-STF), one or more UHR Long Training field (UHR-LTF), a data field, and a packet extension (PE) field.

The L-STF, L-LTF, L-SIG, RL-SIG, U-SIG, and UHR-SIG fields may be referred to as pre-UHR modulated fields. The UHR-STF, one or more UHR-LTF, data, and PE fields may be referred to as UHR modulated fields. In an example, the pre-UHR modulated fields may be modulated/encoded/transmitted onto a non-distributed RU and may be referred to as the non-dRU portion of UHR PPDU 1002. In an example, the UHR modulated fields may be modulated/encoded/transmitted onto a distributed RU and may be referred to as the dRU portion of UHR PPDU 1002.

UHR TB PPDU 1004 may be used by a STA for transmission in response to a triggering frame from an AP. The triggering frame can be a Trigger Frame (TF) control frame or any frame carrying a Triggered Response Scheduling Control subfield.

As shown in FIG. 10, UHR TB PPDU 1004 includes an L-STF, an L-LTF, an L-SIG, an RL-SIG, a U-SIG, a UHR-STF, one or more UHR-LTF, a data field, and a PE field. It is noted that in UHR TB PPDU 1004, unlike UHR PPDU 1002, no UHR-SIG field is present. Further, the duration of the UHR-STF in UHR TB PPDU 1004 is twice the duration of the UHR-STF in UHR PPDU 1002.

The L-STF, L-LTF, L-SIG, RL-SIG, and U-SIG fields may be referred to as pre-UHR modulated fields. The UHR-STF, one or more UHR-LTF, data, and PE fields may be referred to as UHR modulated fields. In an example, the pre- UHR modulated fields may be modulated/encoded/transmitted onto a non-distributed RU and may be referred to as the non-dRU portion of UHR PPDU F1004. In an example, the UHR modulated fields may be modulated/encoded/transmitted onto a distributed RU and may be referred to as the dRU portion of UHR PPDU 1004.

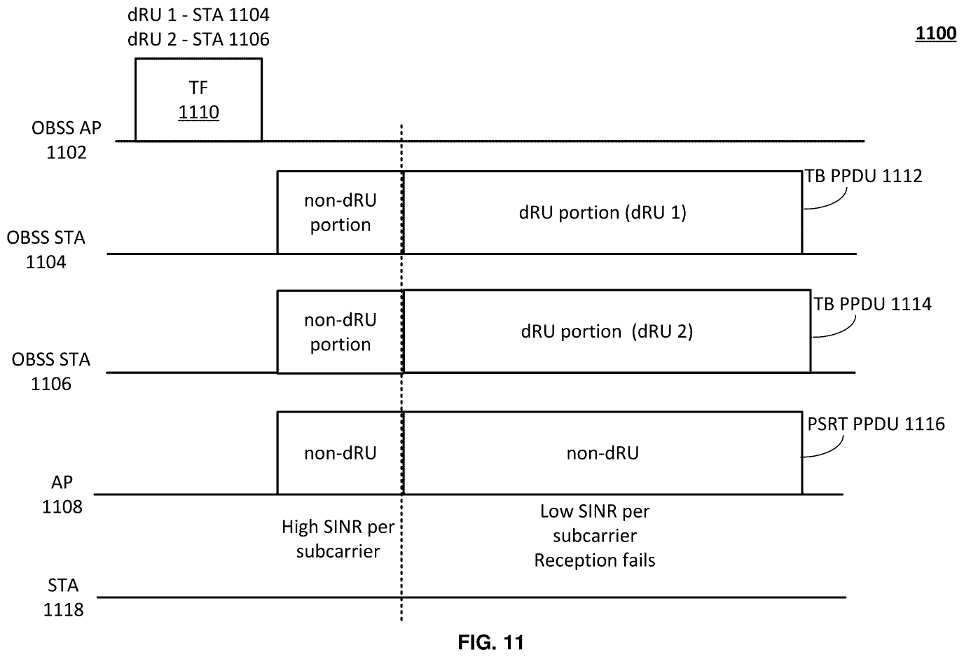

FIG. 11 illustrates another example 1100 of operation using distributed RUs. As shown in FIG. 11, example 1100 includes APs 1102 and 1108 and STAs 1104, 1106, and 1118. AP 1102 may belong to a first BSS. STAs 1104 and 1106 may be associated with AP 1102 and may thus belong to the first BSS. AP 1108 may belong to a second BSS different than the first BSS. STA 1118 may be associated with AP 1108 and may thus belong to the second BSS. The first BSS and the second BSS may operate on the same channel(s) and may have overlapping coverage areas. In example 1100, it is assumed that AP 1102 and STAs 1104 and 1106 belong to an overlapping BSS (OBSS) relative to AP 1108. Hence, AP 1102, STA 1104, and STA 1106 are referred to respectively as OBSS AP 1102, OBSS STA 1104, and OBSS STA 1106 in example 1100.

Example 1100 may begin with OBSS AP 1102 transmitting a trigger frame 1110. Trigger frame 1110 may be similar to trigger frame 500. In example 1100, trigger frame 1110 may solicit an uplink MU transmission from OBSS STAs 1104 and 1106 as described above in FIG. 4. The uplink MU transmission may comprise simultaneous transmissions by OBSS STAs 1104 and 1106 of respective TB PPDUs 1112 and 1114. The uplink MU transmission may be associated with a frequency channel bandwidth over which TB PPDUs 1112 and 1114 are transmitted. Trigger frame 1110 may thus comprise an RU allocation for OBSS STAs 1104 and 1106 to transmit TB PPDUs 1112 and 1114 to OBSS AP 1102. The RU allocation may allocate one or more distributed RUs to each of OBSS STAs 1104 and 1106. In example 1100, the RU allocation may allocate a first distributed RU (dRU 1) to OBSS STA 1104 and a second distributed RU (dRU 2) to OBSS STA 1106. dRU 1 and dRU 2 may be as illustrated in FIG. 8 described above. Specifically, each of dRU 1 and dRU 2 may comprise a non-contiguous set of tones that may be spread over the entire frequency channel bandwidth associated with the uplink MU transmission.

In response to trigger frame 1110, OBSS STAs 1104 and 1106 may transmit respectively TB PPDUs 1112 and 1114. In an example, as shown in FIG. 11, TB PPDUs 1112 and 1114 may each comprise a non-distributed resource portion (non-dRU portion) and a distributed resource portion (dRU portion). The non-dRU portion of TB PPDU 1112 (or TB PPDU 1114) may comprise a preamble portion of TB PPDU 1112 (or TB PPDU 1114). The dRU portion of TB PPDU 1112 (or TB PPDU 1114) may comprise a data portion (comprising a data field) of TB PPDU 1112 (or TB PPDU 1114). In an example, TB PPDUs 1112 and 1114 may be UHR TB PPDUs used by UHR devices according to the IEEE 802.11 standard. In an example, TB PPDUs 1112 and 1114 may have a format as illustrated by TB PPDU 1004 described above with respect to FIG. 10. The non-dRU and dRU portions of TB PPDU 1112 (or TB PPDU 1114) may correspond respectively to the non-dRU portion and the dRU portion of TB PPDU 1004, for example.

In an example, the dRU portions of TB PPDUs 1112 and 1114 may be transmitted over respectively dRU 1 and dRU 2 as indicated by trigger frame 1110. In an example, the non-dRU portion of TB PPDU 1112 (and/or TB PPDU 1114) may be transmitted over one or more non-distributed RUs. The one or more non-distributed RUs may correspond respectively to one or more contiguous sets of resources that may cover respectively one or more parts of the frequency channel bandwidth of the uplink MU transmission. For example, the one or more non-distributed RUs may be as illustrated in FIG. 7 described above. In an example, the non-dRU portions of TB PPDUs 1112 and 1114 may be transmitted over the same or frequency overlapping non-distributed RUs. In another example, the non-dRU portions of TB PPDUs 1112 and 1114 may be transmitted over different or frequency non-overlapping non-distributed RUs. In an example, trigger frame 1110 may indicate the one or more non-distributed RUs for transmission of the non-dRU portions of TB PPDUs 1112 and 1114.

In an example, as OBSS AP 1102 and OBSS STAs 1104 and 1106 belong to an OBSS relative to AP 1108, AP 1108 may hear one or more of trigger frame 1110 and TB PPDUs 1112 and 1114. In example 1100, AP 1108 may hear trigger frame 1110. As described above with respect to example 900, as trigger frame 1110 allocates to OBSS STAs 1104 and 1106 distributed RUs that are spread over the entire frequency channel bandwidth, AP 1108 cannot locate an unused portion of the frequency channel bandwidth according to existing AP behavior as defined by the current IEEE 802.11 standard. In example 1100, AP 1108 may choose to access the wireless medium concurrently with the uplink MU transmission (comprising TB PPDUs 1112 and 1114) by using a spatial reuse scheme. For example, AP 1108 may use PSR-based SR as described above with respect to FIG. 6 to transmit a PSRT PPDU 1116 to STA 1118. As described above in FIG. 6, AP 1108 may transmit PSRT PPDU 1116 when two conditions are met, namely that trigger frame 1110 is an inter-BSS PPDU comprising a trigger frame and that a transmit power of PSRT PPDU 1116 is below a power threshold value PSRT_TXP.

In example 1100, it is assumed that the two conditions are met, and AP 1108 transmits PSRT PPDU 1116 to STA 1118. According to the existing IEEE 802.11 standard, the transmission of PSRT PPDU 1116 may be performed over a non-distributed RU. The non-distributed RU may correspond to a part of or the entirety of the frequency channel bandwidth. That is, as shown in FIG. 11, PSRT PPDU 1116 may not comprise a non-dRU portion transmitted over a non-distributed RU and a dRU portion transmitted over a distributed RU. Instead, the entirety of PSRT PPDU 1116 (both a preamble and a data portion of PSRT PPDU 1116) is transmitted over a non-distributed RU.

The use of spatial reuse by AP 1108 allows an earlier transmission of PSRT PPDU 1116 and may increase the utilization efficiency of the frequency channel bandwidth. However, due to the transmission of TB PPDUs 1112 and 1114 on distributed RUs (dRU1 and dRU2), STA 1118 may experience higher power concentrations and lower signal-to-interference-and-noise ratio (SINR) at the tones associated with dRU 1 and dRU 2. Reception of PSRT PPDU 1116 by STA 1118 may thus fail.

Embodiments of the present disclosure, as further described below, address the above-described problem of existing technologies. In one aspect, embodiments enable a first AP (e.g., OBSS AP) to share with a second AP distributed RUs that are not utilized/allocated by the first AP. The non-utilized/non-allocated distributed RUs may be part of a frequency channel bandwidth of an uplink transmission solicited by the first AP from one or more associated first STAs. The AP may transmit concurrently with the one or more first STAs, increasing the utilization efficiency of the frequency channel bandwidth. The transmission by the AP via non-utilized/non-allocated distributed RUs ensures acceptable SINR at the receiving STA for all tones used by the transmission. Further, the AP may benefit from the use of distributed RUs to lower the PSD and/or increase the transmit power of the transmission.

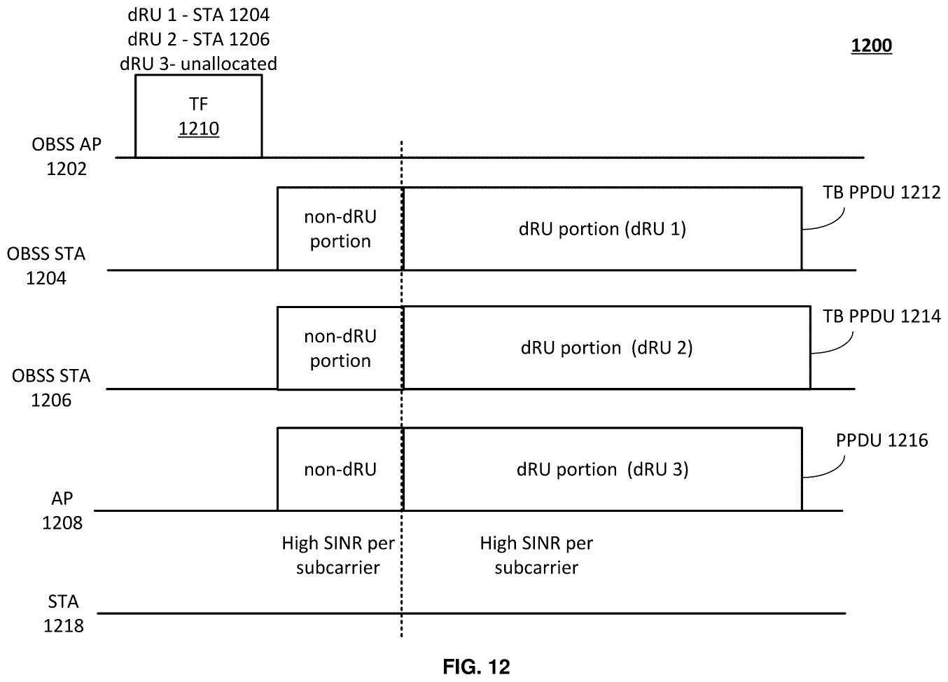

FIG. 12 illustrates an example 1200 of operation using distributed resource units according to an embodiment. As shown in FIG. 12, example 1200 includes APs 1202 and 1208 and STAs 1204, 1206, and 1218. AP 1202 may belong to a first BSS. STAs 1204 and 1206 may be associated with AP 1202 and may thus belong to the first BSS. AP 1208 may belong to a second BSS different than the first BSS. STA 1218 may be associated with AP 1208 and may thus belong to the second BSS. The first BSS and the second BSS may operate on the same channel(s) and may have overlapping coverage areas. In example 1200, it is assumed that AP 1202 and STAs 1204 and 1206 belong to an overlapping BSS (OBSS) relative to AP 1208. Hence, AP 1202, STA 1204, and STA 1206 are referred to respectively as OBSS AP 1202, OBSS STA 1204, and OBSS STA 1206 in example 1200. In an embodiment, APs 1202 and 1208 are part of a coordinated AP set as described with respect to FIG. 3. For example, AP 1202 may be a master AP of the coordinated AP set, and AP 1208 may be a slave AP of the coordinated AP set.

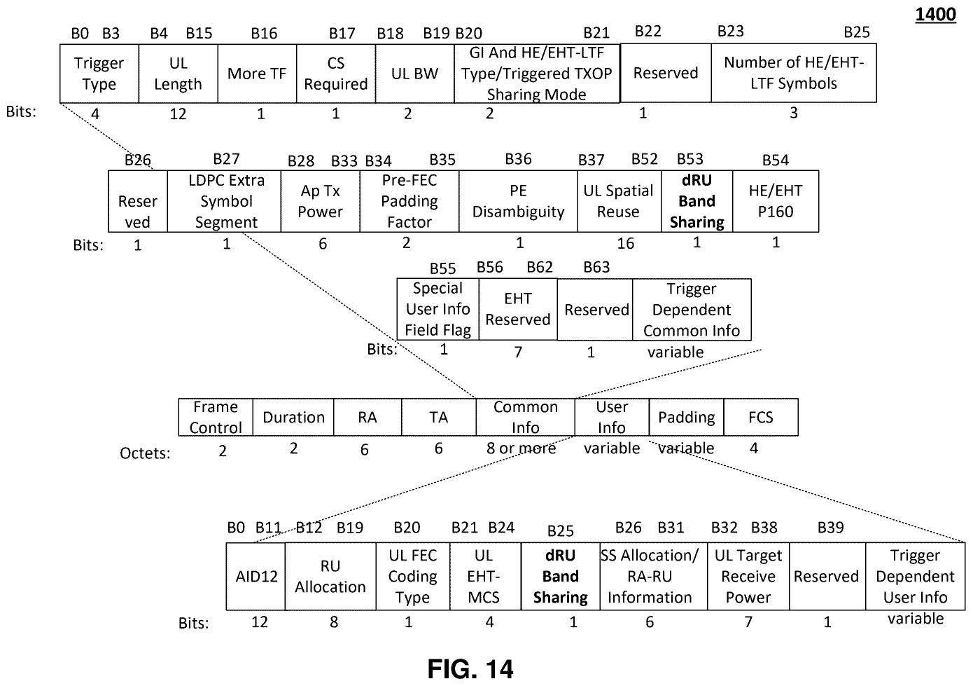

Example 1200 may begin with OBSS AP 1202 transmitting a trigger frame 1210. Trigger frame 1210 may be similar to trigger frame 1400 described with respect to FIG. 14 below. In example 1200, trigger frame 1210 may solicit an uplink MU transmission from OBSS STAs 1204 and 1206 as described above in FIG. 4. The uplink MU transmission may comprise simultaneous transmissions by OBSS STAs 1204 and 1206 of respective TB PPDUs 1212 and 1214. The uplink MU transmission may be associated with a frequency channel bandwidth over which TB PPDUs 1212 and 1214 are transmitted. Trigger frame 1210 may thus comprise an RU allocation for OBSS STAs 1204 and 1206 to transmit TB PPDUs 1212 and 1214 to OBSS AP 1202. The RU allocation may allocate one or more distributed RUs to each of OBSS STAs 1204 and 1206. In example 1200, the RU allocation may allocate a first distributed RU (dRU 1) to OBSS STA 1204 and a second distributed RU (dRU 2) to OBSS STA 1206. dRU 1 and dRU 2 may be as illustrated in FIG. 8 described above. Specifically, each of dRU 1 and dRU 2 may comprise a non-contiguous set of tones that may be spread over the entire frequency channel bandwidth associated with the uplink MU transmission.

In an embodiment, in addition to allocating distributed RUs to OBSS STAs 1204 and 1206, trigger frame 1210 may include an indication of whether distributed RU band sharing (e.g., by an OBSS AP) is enabled over the uplink MU transmission solicited by trigger frame 1210. In an embodiment, as shown in FIG. 14, trigger frame 1210 may comprise a dRU band sharing field that indicates whether distributed RU band sharing is enabled. In an embodiment, as shown in FIG. 14, the dRU band sharing field may be provided in a common info field of trigger frame 1210. For example, the dRU band sharing field may be provided in bit 53 (B53) of the common info field.

In an embodiment, when distributed RU band sharing is enabled in trigger frame 1210, trigger frame 1210 may explicitly indicate one or more distributed RUs available for sharing. In an embodiment, as shown in FIG. 14, trigger frame 1210 may explicitly indicate one or more distributed RUs available for sharing in respective user info fields of trigger frame 1210. For example, in addition to comprising respective user info fields for OBSS STAs 1204 and 1206 indicating respectively dRU1 and dRU2, trigger frame 1210 may comprise one or more additional user info fields indicating one or more non-allocated distributed RUs available for sharing. For example, an additional user info field may indicate in an RU Allocation field (B12 to B19) the non-allocated distributed RU and may indicate in a dRU band sharing field (e.g., B25) whether the non-allocated distributed RU is available for sharing. An AID12 field of the additional user info field may be set to a predetermined association identifier to indicate that the additional user info field is not being allocated to a specific STA.

In another embodiment, trigger frame 1210 may not explicitly indicate any distributed RUs available for sharing. Instead, it is assumed, when distributed RU band sharing is enabled in trigger frame 1210, that any distributed RU within the frequency channel bandwidth that is non-allocated in trigger frame 1210 is available for sharing. In an embodiment, available distributed RUs within the frequency channel bandwidth are associated with respective indices. As such, a STA or AP that receives trigger frame 1210 may determine distributed RUs available for sharing as those distributed RUs which indices are not indicated in trigger frame 1210.

In example 1200, it is assumed that distributed RU band sharing is enabled in trigger frame 1210. It is further assumed that trigger frame 1210 explicitly indicates a non-allocated distributed RU, dRU 3, as available for sharing.

In response to trigger frame 1210, OBSS STAs 1204 and 1206 may transmit respectively TB PPDUs 1212 and 1214. In an example, as shown in FIG. 12, TB PPDUs 1212 and 1214 may each comprise a non-distributed resource portion (non-dRU portion) and a distributed resource portion (dRU portion). The non-dRU portion of TB PPDU 1212 (or TB PPDU 1214) may comprise a preamble portion of TB PPDU 1212 (or TB PPDU 1214). The dRU portion of TB PPDU 1212 (or TB PPDU 1214) may comprise a data portion (comprising a data field) of TB PPDU 1212 (or TB PPDU 1214). In an example, TB PPDUs 1212 and 1214 may be UHR TB PPDUs used by UHR devices according to the IEEE 802.12 standard. In an example, TB PPDUs 1212 and 1214 may have a format as illustrated by TB PPDU 1004 described above with respect to FIG. 10. The non-dRU and dRU portions of TB PPDU 1212 (or TB PPDU 1214) may correspond respectively to the non-dRU portion and the dRU portion of TB PPDU 1004, for example.

In an example, the dRU portions of TB PPDUs 1212 and 1214 may be transmitted over respectively dRU 1 and dRU 2 as indicated by trigger frame 1210. In an example, the non-dRU portion of TB PPDU 1212 (and/or TB PPDU 1214) may be transmitted over one or more non-distributed RUs. The one or more non-distributed RUs may correspond respectively to one or more contiguous sets of resources that may cover respectively one or more parts of the frequency channel bandwidth of the uplink MU transmission. For example, the one or more non-distributed RUs may be as illustrated in FIG. 7 described above. In an example, the non-dRU portions of TB PPDUs 1212 and 1214 may be transmitted over the same or frequency overlapping non-distributed RUs. In another example, the non-dRU portions of TB PPDUs 1212 and 1214 may be transmitted over different or frequency non-overlapping non-distributed RUs. In an example, trigger frame 1210 may indicate the one or more non-distributed RUs for transmission of the non-dRU portions of TB PPDUs 1212 and 1214.

On receiving trigger frame 1210, AP 1208 may determine whether distributed RU band sharing is enabled over the uplink MU transmission solicited by trigger frame 1210. In an embodiment, when distributed RU band sharing is enabled by trigger frame 1210, AP 1208 may not update its NAV based on trigger frame 1210. This allows AP 1208 to access the wireless medium over the uplink MU transmission solicited by trigger frame 1210. In an embodiment, if distributed RU band sharing is enabled, AP 1208 may determine whether trigger frame 1210 explicitly indicates one or more distributed RUs available for RU sharing.

In example 1200, trigger frame 1210 indicates a third distributed RU (dRU 3) as available for sharing. AP 1208 may choose to access the wireless medium concurrently with the uplink MU transmission (comprising TB PPDUs 1212 and 1214) to transmit a PPDU 1216 via dRU 3 to STA 1218. In an example, as shown in FIG. 12, PPDU 1216 may comprise a non-distributed resource portion (non-dRU portion) and a distributed resource portion (dRU portion). The non-dRU portion of PPDU 1216 may comprise a preamble portion of PPDU 1216. The dRU portion of PPDU 1216 may comprise a data portion (comprising a data field) of PPDU 1216. In an example, PPDU 1216 may be a UHR PPDU used by UHR devices according to the IEEE 802.12 standard. In an example, PPDU 1216 may have a format as illustrated by PPDU 1002 described above with respect to FIG. 10. The non-dRU and dRU portions of PPDU 1216 may correspond respectively to the non-dRU and dRU portions of PPDU 1002, for example.

In an example, the dRU portion of PPDU 1216 may be transmitted over dRU 3 as indicated by trigger frame 1210. In an example, the non-dRU portion of PPDU 1216 may be transmitted over one or more non-distributed RUs. The one or more non-distributed RUs may correspond respectively to one or more contiguous sets of resources that may cover respectively one or more parts of the frequency channel bandwidth of the uplink MU transmission. For example, the one or more non-distributed RUs may be as illustrated in FIG. 7 described above. In an example, the non-dRU portion of PPDU 1216 may be transmitted over the same or frequency overlapping non-distributed RUs as the non-dRU portion of TB PPDU 1212 and/or the non-dRU portion of TB PPDU 1214. In such an example, OBSS AP 1202 may control the transmit power used by OBSS STA 1204 and/or OBSS STA 1206 to transmit the non-dRU portion of TB PPDU 1212 and/or the non-dRU portion of TB PPDU 1214 respectively. In another example, the non-dRU portion of PPDU 1216 may be transmitted over different or frequency non-overlapping non-distributed RUs as the non-dRU portion of TB PPDU 1212 and/or the non-dRU portion of TB PPDU 1214. In an example, trigger frame 1210 may indicate the one or more non-distributed RUs for transmission of the non-dRU portion of PPDU 1216.

In an embodiment, AP 1208 may transmit the dRU portion (comprising the data portion) of PPDU 1216 using a first transmit power. In an embodiment, AP 1208 may transmit the non-dRU portion (comprising a non-data portion) of PPDU 1216 using a second transmit power. In an embodiment, the first transmit power is higher than the second transmit power. In an embodiment, AP 1208 determines the second transmit power based on a parameter indicated in trigger frame 1210.

The use of dRU 3 by AP 1208 allows an earlier transmission of PPDU 1216 and increases the utilization efficiency of the frequency channel bandwidth. Further, as dRU3 is orthogonal to both dRU 1 and dRU2, the higher power per subcarrier used over dRU 1 and dRU 2 by OBSS STAs 1204 and 1206 does not impact the SINR of PPDU 1216 at STA 1218. PPDU 1216 may thus be received successfully by STA 1218.

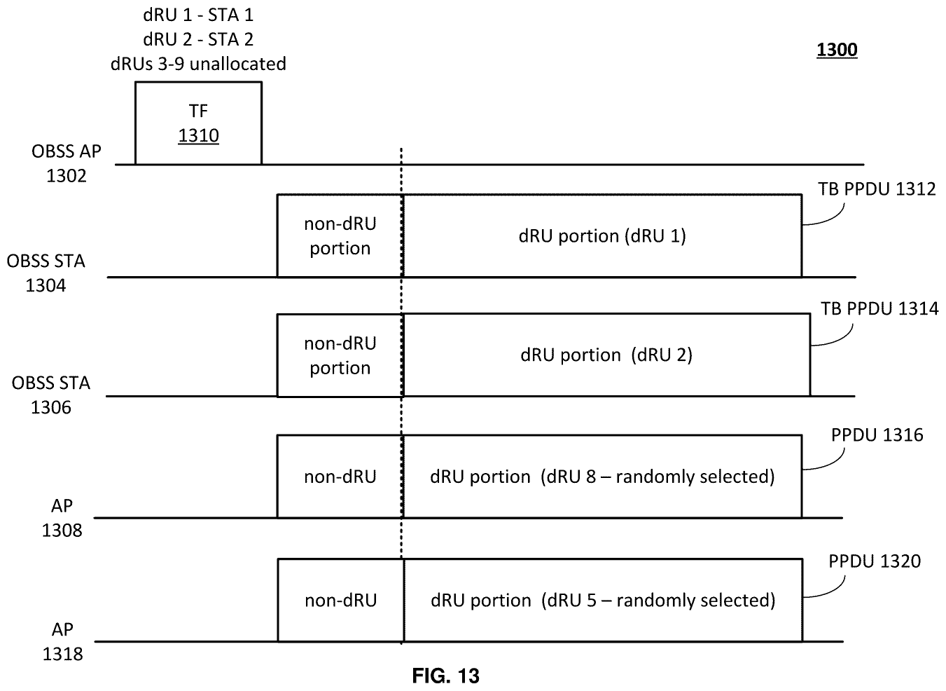

FIG. 13 illustrates another example 1300 of operation using distributed resource units according to an embodiment. As shown in FIG. 13, example 1300 includes APs 1302, 1308, and 1318 and STAs 1304 and 1306. AP 1302 may belong to a first BSS. STAs 1304 and 1306 may be associated with AP 1302 and may thus belong to the first BSS. APs 1308 and 1318 may belong respectively to a second BSS and a third BSS, both different than the first BSS. The first BSS, second BSS, and third BSS may operate on the same channel(s) and may have overlapping coverage areas. In example 1300, it is assumed that AP 1302 and STAs 1304 and 1306 belong to an overlapping BSS (OBSS) relative to AP 1308 or AP 1318. Hence, AP 1302, STA 1304, and STA 1306 are referred to respectively as OBSS AP 1302, OBSS STA 1304, and OBSS STA 1306 in example 1300. In an embodiment, APs 1302, 1308, and 1318s are part of a coordinated AP set as described with respect to FIG. 3. For example, AP 1302 may be a master AP of the coordinated AP set, and APs 1308 and 1318 may be slave APs of the coordinated AP set.

Example 1300 may begin with OBSS AP 1302 transmitting a trigger frame 1310. Trigger frame 1310 may be similar to trigger frame 1400 described with respect to FIG. 14 below. In example 1300, trigger frame 1310 may solicit an uplink MU transmission from OBSS STAs 1304 and 1306 as described above in FIG. 4. The uplink MU transmission may comprise simultaneous transmissions by OBSS STAs 1304 and 1306 of respective TB PPDUs 1312 and 1314. The uplink MU transmission may be associated with a frequency channel bandwidth over which TB PPDUs 1312 and 1314 are transmitted. Trigger frame 1310 may thus comprise an RU allocation for OBSS STAs 1304 and 1306 to transmit TB PPDUs 1312 and 1314 to OBSS AP 1302. The RU allocation may allocate one or more distributed RUs to each of OBSS STAs 1304 and 1306. In example 1300, the RU allocation may allocate a first distributed RU (dRU 1) to OBSS STA 1304 and a second distributed RU (dRU 2) to OBSS STA 1306. dRU 1 and dRU 2 may be as illustrated in FIG. 8 described above. Specifically, each of dRU 1 and dRU 2 may comprise a non-contiguous set of tones that may be spread over the entire frequency channel bandwidth associated with the uplink MU transmission.

In an embodiment, in addition to allocating distributed RUs to OBSS STAs 1304 and 1306, trigger frame 1310 may include an indication of whether distributed RU band sharing (e.g., by an OBSS AP) is enabled over the uplink MU transmission solicited by trigger frame 1310. In an embodiment, as shown in FIG. 14, trigger frame 1310 may comprise a dRU band sharing field that indicates whether distributed RU band sharing is enabled. In an embodiment, as shown in FIG. 14, the dRU band sharing field may be provided in a common info field of trigger frame 1310. For example, the dRU band sharing field may be provided in bit 53 (B53) of the common info field.

In an embodiment, when distributed RU band sharing is enabled in trigger frame 1310, trigger frame 1310 may explicitly indicate one or more distributed RUs available for sharing. In an embodiment, as shown in FIG. 14, trigger frame 1310 may explicitly indicate one or more distributed RUs available for sharing in respective user info fields of trigger frame 1310. For example, in addition to comprising respective user info fields for OBSS STAs 1304 and 1306 indicating respectively dRU1 and dRU2, trigger frame 1310 may comprise one or more additional user info fields indicating one or more non-allocated distributed RUs available for sharing. For example, an additional user info field may indicate in an RU Allocation field (B13 to B19) the non-allocated distributed RU and may indicate in a dRU band sharing field (e.g., B25) whether the non-allocated distributed RU is available for sharing. An AID12 field of the additional user info field may be set to a predetermined association identifier to indicate that the additional user info field is not being allocated to a specific STA. For example, an AID12 value of 2046 is used in the IEEE 802.11 standard to indicate unallocated RUs. Moreover, a value in the range of 2008 to 2044 may also be used to indicate unallocated RUs for the purpose of dRU band sharing.

In another embodiment, trigger frame 1310 may not explicitly indicate any distributed RUs available for sharing. Instead, it is assumed, when distributed RU band sharing is enabled in trigger frame 1310, that any distributed RU within the frequency channel bandwidth that is non-allocated in trigger frame 1310 is available for sharing. In an embodiment, available distributed RUs within the frequency channel bandwidth are associated with respective indices. As such, a STA or AP that receives trigger frame 1310 may determine distributed RUs available for sharing as those distributed RUs which indices are not indicated in trigger frame 1310.

In example 1300, it is assumed that distributed RU band sharing is enabled in trigger frame 1310. It is further assumed that trigger frame 1310 explicitly indicates a plurality of non-allocated distributed RUs (dRUs 3 to 9) as available for sharing.

In response to trigger frame 1310, OBSS STAs 1304 and 1306 may transmit respectively TB PPDUs 1312 and 1314. In an example, as shown in FIG. 13, TB PPDUs 1312 and 1314 may each comprise a non-distributed resource portion (non-dRU portion) and a distributed resource portion (dRU portion). The non-dRU portion of TB PPDU 1312 (or TB PPDU 1314) may comprise a preamble portion of TB PPDU 1312 (or TB PPDU 1314). The dRU portion of TB PPDU 1312 (or TB PPDU 1314) may comprise a data portion (comprising a data field) of TB PPDU 1312 (or TB PPDU 1314). In an example, TB PPDUs 1312 and 1314 may be UHR TB PPDUs used by UHR devices according to the IEEE 802.13 standard. In an example, TB PPDUs 1312 and 1314 may have a format as illustrated by TB PPDU 1004 described above with respect to FIG. 10. The non-dRU and dRU portions of TB PPDU 1312 (or TB PPDU 1314) may correspond respectively to the non-dRU portion and the dRU portion of TB PPDU 1004, for example.

In an example, the dRU portions of TB PPDUs 1312 and 1314 may be transmitted over respectively dRU 1 and dRU 2 as indicated by trigger frame 1310. In an example, the non-dRU portion of TB PPDU 1312 (and/or TB PPDU 1314) may be transmitted over one or more non-distributed RUs. The one or more non-distributed RUs may correspond respectively to one or more contiguous sets of resources that may cover respectively one or more parts of the frequency channel bandwidth of the uplink MU transmission. For example, the one or more non-distributed RUs may be as illustrated in FIG. 7 described above. In an example, the non-dRU portions of TB PPDUs 1312 and 1314 may be transmitted over the same or frequency overlapping non-distributed RUs. In another example, the non-dRU portions of TB PPDUs 1312 and 1314 may be transmitted over different or frequency non-overlapping non-distributed RUs. In an example, trigger frame 1310 may indicate the one or more non-distributed RUs for transmission of the non-dRU portions of TB PPDUs 1312 and 1314.

On receiving trigger frame 1310, AP 1308 and/or AP 1318 may determine whether distributed RU band sharing is enabled over the uplink MU transmission solicited by trigger frame 1310. In an embodiment, when distributed RU band sharing is enabled by trigger frame 1310, AP 1308 and/or AP 1318 may not update its NAV based on trigger frame 1310. This allows AP 1308 and/or AP 1318 to access the wireless medium over the uplink MU transmission solicited by trigger frame 1310. In an embodiment, if distributed RU band sharing is enabled, AP 1308 and/or AP 1318 may determine whether trigger frame 1310 explicitly indicates one or more distributed RUs available for RU sharing.

In example 1300, trigger frame 1310 explicitly indicates a plurality of non-allocated distributed RUs (dRUs 3 to 9) as available for sharing. In an embodiment, AP 1308 and/or AP 1318 may choose to access the wireless medium concurrently with the uplink MU transmission (comprising TB PPDUs 1312 and 1314) to transmit a respective PPDU via one of the indicated plurality of non-allocated distributed RUs. In an embodiment, AP 1308 and/or AP 1318 may randomly select one of the indicated plurality of non-allocated distributed RUs for transmission of its respective PPDU. In example 1300, AP 1308 may randomly select dRU 8 to transmit a PPDU 1316, and AP 1318 may randomly select dRU 5 to transmit a PPDU 1320.

In an example, as shown in FIG. 13, PPDU 1316 and/or PPDU 1320 may comprise a non-distributed resource portion (non-dRU portion) and a distributed resource portion (dRU portion). The non-dRU portion of PPDU 1316 or PPDU 1320 may comprise a preamble portion of PPDU 1316 or PPDU 1320. The dRU portion of PPDU 1316 or PPDU 1320 may comprise a data portion (comprising a data field) of PPDU 1316 or PPDU 1320. In an example, PPDU 1316 and/or PPDU 1320 may be a UHR PPDU used by UHR devices according to the IEEE 802.11 standard. In an example, PPDU 1316 and/or PPDU 1320 may have a format as illustrated by PPDU 1002 described above with respect to FIG. 10. The non-dRU and dRU portions of PPDU 1312 (or PPDU 1314) may correspond respectively to the non-dRU and dRU portions of PPDU 1002, for example.

In an example, the dRU portion of PPDU 1316 may be transmitted over dRU 8, and the dRU portion of PPDU 1320 may be transmitted over dRU 5. In an example, the non-dRU portion of PPDU 1316 and/or PPDU 1320 may be transmitted over one or more non-distributed RUs. The one or more non-distributed RUs may correspond respectively to one or more contiguous sets of resources that may cover respectively one or more parts of the frequency channel bandwidth of the uplink MU transmission. For example, the one or more non-distributed RUs may be as illustrated in FIG. 7 described above. In an example, the non-dRU portion of PPDU 1316 and/or PPDU 1320 may be transmitted over the same or frequency overlapping non-distributed RUs as the non-dRU portion of TB PPDU 1312 and/or the non-dRU portion of TB PPDU 1314. In such an example, OBSS AP 1302 may control the transmit power used by OBSS STA 1304 and/or OBSS STA 1306 to transmit the non-dRU portion of TB PPDU 1312 and/or the non-dRU portion of TB PPDU 1314 respectively. In another example, the non-dRU portion of PPDU 1316 and/or PPDU 1320 may be transmitted over different or frequency non-overlapping non-distributed RUs as the non-dRU portion of TB PPDU 1312 and/or the non-dRU portion of TB PPDU 1314. In an example, trigger frame 1310 may indicate the one or more non-distributed RUs for transmission of the non-dRU portion of PPDU 1316 and/or PPDU 1320.

In an embodiment, AP 1308 (or AP 1318) may transmit the dRU portion (comprising the data portion) of PPDU 1316 (or PPDU 1320) using a first transmit power. In an embodiment, AP 1308 (or AP 1318) may transmit the non-dRU portion (comprising a non-data portion) of PPDU 1316 (or PPDU 1320) using a second transmit power. In an embodiment, the first transmit power is higher than the second transmit power. In an embodiment, AP 1308 (or AP 1318) determines the second transmit power based on a parameter indicated in trigger frame 1310.

The use of dRU 5 by AP 1308 and of dRU 8 by AP 1318 allows an earlier transmission of PPDUs 1316 and 1320 and increases the utilization efficiency of the frequency channel bandwidth. Further, as dRU5 and dRU8 are each orthogonal to both dRU 1 and dRU2, the higher power per subcarrier used over dRU 1 and dRU 2 by OBSS STAs 1304 and 1306 does not impact the SINR of PPDUs 1316 and 1320 at their respective receiving STAs. PPDUs 1316 and 1320 may thus be received successfully by their respective receiving STAs.

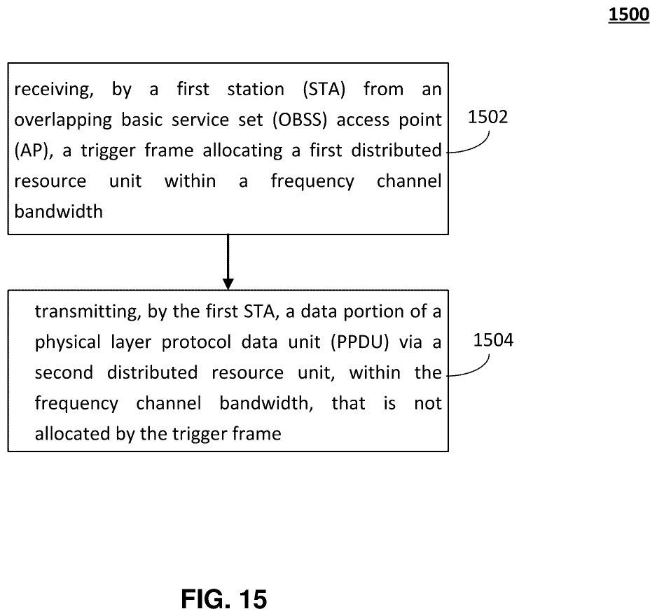

FIG. 15 illustrates an example process 1500 according to an embodiment. Example process 1500 may be performed a first STA (AP STA or non-AP STA). The first STA may belong to a first BSS. The first BSS may overlap in coverage area within a second BSS. The second BSS may be considered as an OBSS with respect to the first STA. As shown in FIG. 15, example process 1500 may include steps 1502 and 1504.

Step 1502 includes receiving, by the first STA from an OBSS AP, a trigger frame allocating a first distributed resource unit within a frequency channel bandwidth. The OBSS AP may be an AP of the second BSS. The trigger frame may be similar to trigger frame 1400 described with respect to FIG. 14 above. The trigger frame may solicit an uplink transmission from one or more OBSS STAs. The uplink transmission may comprise transmissions by the one or more OBSS STAs of one or more TB PPDUs. The frequency channel bandwidth may correspond to a frequency channel bandwidth associated with the uplink transmission over which the one or more TB PPDUs are transmitted by the one or more OBSS STAs. The trigger frame may allocate the first distributed resource unit to a second STA associated with the OBSS AP. The first distributed resource unit may comprise a non-contiguous set of tones spread over the frequency channel bandwidth.

In an embodiment, the trigger frame indicates whether distributed resource unit band sharing is enabled by the trigger frame.

In an embodiment, process 1500 may further comprise determining, by the first STA, whether distributed resource unit band sharing is enabled by the trigger frame. In an embodiment, where distributed resource unit band sharing is enabled by the trigger frame, process 1500 may further comprise determining a second distributed resource unit, within the frequency channel bandwidth, that is not allocated by the trigger frame.

In an embodiment, the second distributed resource unit is indicated in the trigger frame. In an embodiment, the second distributed resource unit is provided in a user info field of the trigger frame. In an embodiment, the user info field is associated with a predetermined association identifier. The predetermined association identifier does not correspond to an association identifier of a STA associated with the OBSS AP.

In an embodiment, the trigger frame explicitly indicates one or more non-allocated distributed resource units available for distributed resource unit band sharing. In an embodiment, process 1500 may further comprise selecting one of the indicated one or more distributed resource units as the second distributed resource unit. In an embodiment, determining the second distributed resource unit comprises randomly selecting one of a plurality of indicated distributed resource units as the second distributed resource unit.

In another embodiment, the second distributed resource unit is not indicated in the trigger frame. In an embodiment, determining the second distributed resource unit may comprise determining a non-allocated distributed resource unit based on the distributed resource units allocated in the trigger frame. In an embodiment, available distributed resource units within the frequency channel bandwidth are associated with respective indices, and determining the second distributed resource unit may comprise determining a distributed resource unit which index is not indicated in the trigger frame

In an embodiment, where distributed resource unit band sharing is enabled by the trigger frame, process 1500 may further comprise resetting (or not updating), by the first STA, a NAV set based on the trigger frame. Resetting the NAV by the first STA may comprise resetting to zero the NAV set based on the trigger frame.

In an embodiment, where distributed resource unit band sharing is not enabled by the trigger frame, process 1500 may further comprise setting, by the first STA, a NAV based on the trigger frame.

Step 1504 comprises transmitting, by the first STA, a data portion (comprising a data field) of a first PPDU via the second distributed resource unit that is not allocated by the trigger frame.

In an embodiment, process 1500 may further comprise transmitting a non-data (e.g., comprising a preamble but no data) portion of the first PPDU via a non-distributed resource unit within the frequency channel bandwidth. The non-distributed resource unit may comprise one or more 20 MHz subchannel within the frequency channel bandwidth.

In an embodiment, transmitting the data portion of the first PPDU via the second distributed resource unit comprises transmitting the data portion of the first PPDU using a first transmit power. In an embodiment, transmitting the non-data portion of the first PPDU via the non-distributed resource unit comprises transmitting the non-data portion of the first PPDU via a second transmit power. In an embodiment, the first transmit power is higher than the second transmit power. In an embodiment, the second transmit power is determined based on a parameter indicated by the trigger frame.

In an embodiment, the non-data portion of the first PPDU overlaps a non-data (e.g., preamble) portion of a second PPDU transmitted by the second STA.

In an embodiment, the data portion of the first PPDU is transmitted simultaneously with a data portion of a second PPDU transmitted by the second STA via the first distributed resource unit.

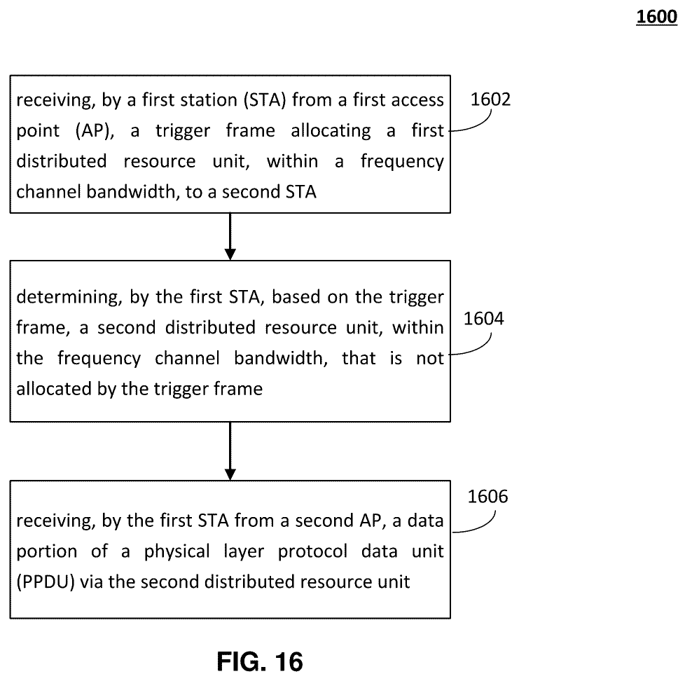

FIG. 16 illustrates another example process 1600 according to an embodiment. Example process 1600 may be performed a first STA (e.g., non-AP STA). The first STA may belong to a first BSS. The first BSS may overlap in coverage area within a second BSS. The second BSS may be considered as an OBSS with respect to the first STA. As shown in FIG. 16, example process 1600 may include steps 1602, 1604, and 1606.

Step 1602 includes receiving, by a first station (STA) from a first access point (AP), a trigger frame allocating a first distributed resource unit, within a frequency channel bandwidth, to a second STA. The first AP may be an AP of the second BSS (OBSS AP). The trigger frame may be similar to trigger frame 1400 described with respect to FIG. 14 above. The trigger frame may solicit an uplink transmission from one or more OBSS STAs including the second STA. The uplink transmission may comprise transmissions by the one or more OBSS STAs of one or more TB PPDUs. The frequency channel bandwidth may correspond to a frequency channel bandwidth associated with the uplink transmission over which the one or more TB PPDUs are transmitted by the one or more OBSS STAs. The first distributed resource unit may comprise a non-contiguous set of tones spread over the frequency channel bandwidth.

In an embodiment, the trigger frame indicates whether distributed resource unit band sharing is enabled by the trigger frame. In an embodiment, process 1600 may further comprise determining, by the first STA, whether distributed resource unit band sharing is enabled by the trigger frame.

Step 1604 includes determining, by the first STA, based on the trigger frame, a second distributed resource unit, within the frequency channel bandwidth, that is not allocated by the trigger frame.

In an embodiment, the second distributed resource unit is indicated in the trigger frame. In an embodiment, the second distributed resource unit is provided in a user info field of the trigger frame. In an embodiment, the user info field is associated with a predetermined association identifier. The predetermined association identifier does not correspond to an association identifier of a STA associated with the OBSS AP.

In an embodiment, the trigger frame explicitly indicates one or more non-allocated distributed resource units available for distributed resource unit band sharing.

In another embodiment, the second distributed resource unit is not indicated in the trigger frame. In an embodiment, determining the second distributed resource unit may comprise determining a non-allocated distributed resource unit based on the distributed resource units allocated in the trigger frame. In an embodiment, available distributed resource units within the frequency channel bandwidth are associated with respective indices, and determining the second distributed resource unit may comprise determining a distributed resource unit which index is not indicated in the trigger frame

In an embodiment, where distributed resource unit band sharing is enabled by the trigger frame, process 1600 may further comprise resetting (or not updating), by the first STA, a NAV set based on the trigger frame. Resetting the NAV by the first STA may comprise resetting to zero the NAV set based on the trigger frame.

In an embodiment, where distributed resource unit band sharing is not enabled by the trigger frame, process 1600 may further comprise setting, by the first STA, a NAV based on the trigger frame.

Step 1606 includes receiving, by the first STA from a second AP, a data portion of a physical layer protocol data unit (PPDU) via the second distributed resource unit. The second AP may be an AP with which the first STA is associated.

In an embodiment, process 1600 may further comprise receiving a non-data portion of the PPDU via a non-distributed resource unit within the frequency channel bandwidth. The non-distributed resource unit may comprise one or more 20 MHz subchannels within the frequency channel bandwidth. The non-data portion of the PPDU may overlap a non-data portion of a second PPDU transmitted by the second STA. The data portion of the second PPDU may be transmitted via the first distributed resource unit allocated in the trigger frame.

In an embodiment, a first received power of the data portion of the PPDU (received via the second distributed resource unit) is higher than a second received power of the non-data portion of the PPDU (received via the non-distributed resource unit).

1. A method comprising:
receiving, by a station (STA) from an access point (AP), a trigger frame;
transmitting, by the STA to the AP and in response to the trigger frame, a physical layer protocol data unit (PPDU) comprising one or more pre-ultra high reliability (UHR) modulated fields and one or more UHR modulated fields, wherein:
the one or more UHR modulated fields comprise a data frame;
the STA transmits the one or more pre-UHR modulated fields via a non-distributed resource unit and using a first transmit power;
the STA transmits the one or more UHR modulated fields via a distributed resource unit and using a second transmit power; and
the second transmit power used to transmit the one or more UHR modulated fields via the distributed resource unit is higher than the first transmit power used to transmit the one or more pre-UHR modulated fields via the non-distributed resource unit; and
receiving, by the STA from the AP, an acknowledgement frame for the data frame.

2. The method of claim 1, wherein the one or more pre-UHR modulated fields comprise one or more of a legacy-short training (L-STF) field, a legacy-long training (L-LTF) field, a legacy-signal (L-SIG) field, a repeated legacy-signal (RL-SIG) field, or a universal-signal (U-SIG) field.

3. The method of claim 2, wherein the one or more pre-UHR modulated fields comprise the U-SIG field.

4. The method of claim 3, wherein the one or more pre-UHR modulated fields further comprise the L-STF field, the L-LTF field, the L-SIG field, and the RL-SIG field.

5. The method of claim 1, wherein the distributed resource unit used to transmit the one or more UHR modulated fields is allocated within a frequency channel bandwidth.

6. The method of claim 5, wherein the STA transmits the one or more pre-UHR modulated fields using a 20 MHz subchannel within the frequency channel bandwidth.

7. The method of claim 6, wherein the one or more pre-UHR modulated fields are preamble fields for the PPDU and wherein the STA duplicates the one or more pre-UHR modulated fields over a plurality of 20 MHz subchannels within the frequency channel bandwidth.

8. A station (STA) comprising:
one or more processors; and
memory storing instructions that, when executed by the one or more processors, cause the STA to:
receive, from an access point (AP), a trigger frame;
transmit, to the AP and in response to the trigger frame, a physical layer protocol data unit (PPDU) comprising one or more pre-ultra high reliability (UHR) modulated fields and one or more UHR modulated fields, wherein:
the one or more UHR modulated fields comprise a data frame;
the STA transmits the one or more pre-UHR modulated fields via a non-distributed resource unit and using a first transmit power;
the STA transmits the one or more UHR modulated fields via a distributed resource unit and using a second transmit power; and
the second transmit power used to transmit the one or more UHR modulated fields via the distributed resource unit is higher than the first transmit power used to transmit the one or more pre-UHR modulated fields via the non-distributed resource unit; and
receive, from the AP, an acknowledgement frame for the data frame.

9. The STA of claim 8, wherein the one or more pre-UHR modulated fields comprise one or more of a legacy-short training (L-STF) field, a legacy-long training (L-LTF) field, a legacy-signal (L-SIG) field, a repeated legacy-signal (RL-SIG) field, or a universal-signal (U-SIG) field.

10. The STA of claim 9, wherein the one or more pre-UHR modulated fields comprise the U-SIG field.

11. The STA of claim 10, wherein the one or more pre-UHR modulated fields further comprise the L-STF field, the L-LTF field, the L-SIG field, and the RL-SIG field.

12. The STA of claim 8, wherein the distributed resource unit used to transmit the one or more UHR modulated fields is allocated within a frequency channel bandwidth.

13. The STA of claim 12, wherein the STA transmits the one or more pre-UHR modulated fields using a 20 MHz subchannel within the frequency channel bandwidth.

14. The STA of claim 13, wherein the one or more pre-UHR modulated fields are preamble fields for the PPDU and wherein the STA duplicates the one or more pre-UHR modulated fields over a plurality of 20 MHz subchannels within the frequency channel bandwidth.

15. A non-transitory computer-readable medium comprising instructions that, when executed by one or more processors of a station (STA), cause the STA to:
receive, from an access point (AP), a trigger frame;
transmit, to the AP and in response to the trigger frame, a physical layer protocol data unit (PPDU) comprising one or more pre-ultra high reliability (UHR) modulated fields and one or more UHR modulated fields, wherein:
the one or more UHR modulated fields comprise a data frame;
the STA transmits the one or more pre-UHR modulated fields via a non-distributed resource unit and using a first transmit power;
the STA transmits the one or more UHR modulated fields via a distributed resource unit and using a second transmit power; and
the second transmit power used to transmit the one or more UHR modulated fields via the distributed resource unit is higher than the first transmit power used to transmit the one or more pre-UHR modulated fields via the non-distributed resource unit; and
receive, from the AP, an acknowledgement frame for the data frame.

16. The non-transitory computer-readable medium of claim 15, wherein the one or more pre-UHR modulated fields comprise one or more of a legacy-short training (L-STF) field, a legacy-long training (L-LTF) field, a legacy-signal (L-SIG) field, a repeated legacy-signal (RL-SIG) field, or a universal-signal (U-SIG) field.

17. The non-transitory computer-readable medium of claim 16, wherein the one or more pre-UHR modulated fields comprise the U-SIG field, L-STF field, the L-LTF field, the L-SIG field, and the RL-SIG field.

18. The non-transitory computer-readable medium of claim 15, wherein the distributed resource unit used to transmit the one or more UHR modulated fields is allocated within a frequency channel bandwidth.

19. The non-transitory computer-readable medium of claim 18, wherein the STA transmits the one or more pre-UHR modulated fields using a 20 MHz subchannel within the frequency channel bandwidth.

20. The non-transitory computer-readable medium of claim 19, wherein the one or more pre-UHR modulated fields are preamble fields for the PPDU and wherein the STA duplicates the one or more pre-UHR modulated fields over a plurality of 20 MHz subchannels within the frequency channel bandwidth.
